(19) United States
(12) Patent Application Publication
(10) Pub. No.: US 2004/0168064 A1
(43) Pub. Date: Aug. 26, 2004

(54) System of generating procedure for digital signature and encryption to XML

(76) Inventors: Shougo Shimizu, Hiroshima (JP); Hideaki Sunada, Yokohama (JP); Hidenori Shimizu, Yokohama (JP); Shunsuke Akifuji, Wakou (JP); Yutaka Kudo, Yokohama (JP)

Correspondence Address: MCDERMOTT, WILL & EMERY, 600 13th Street, N.W., Washington, DC, 20005-3096, US

(21) Appl. No.: 10/661,814

(22) Filed: Sep. 15, 2003

(30) Foreign Application Priority Data
Feb. 25, 2003 (JP) 2003-046683

(51) Int. Cl. H04L 9/00

(52) U.S. Cl. 713/176

(57) ABSTRACT

As an XML signature and encryption procedure analyzing section 107 is executed on the basis of input of an XML signature and encryption procedure list 106 and an XML schema 108 of a target element, an XML signature and encryption procedure 109 that meets all the required procedures is outputted. An XML signature and encryption module output section 110 generates a module 111 for performing digital signature and encryption to XML with reference to the XML signature and encryption procedure 109.

### BACKGROUND OF THE INVENTION

1. Field of the Invention

This invention relates to a method for performing digital signature and encryption to XML.

2. Description of the Related Art

Conventionally, in the development of a system for performing digital signature or encryption, a developer manually develops an application for signature or encryption and an application for verification of signature or decription on the basis of a procedure for signature or encryption designed in advance in an upstream process.

As methods for signature and encryption of XML documents, techniques called digital signature and encryption to XML have been standardized by W3C, which is an organization for standardization. These techniques enable signature and encryption of a part of an XML document. Moreover, plural signature data and encrypted data can be expressed within the same XML document. As known techniques related to signature in XML documents, for example, a method for generating digital signature and a method for authenticating a digital document that enable change of the document contents during its circulation are described in JP-A-6-224896.

Each web service is independently designed. Therefore, in the development of a web service utilizing an existing web service, it is necessary to perform signature and encryption in accordance with a procedure for signature and encryption required by the web service to be used. Particularly in the case of using plural web services, in order to meet all the procedures for signature and encryption that are independently required by the respective web services, a developer must manually check the procedures for signature and encryption and develop a program for performing signature and encryption in accordance with those procedures. For example, if web services A and B require encryption to XML of two elements “parent” and “child” of set membership and the contents of the child element must not be visible to A, it is necessary to first encrypt the child element to XML with respect to B and then encrypt the parent element with respect to A.

### SUMMARY OF THE INVENTION

It is an object of the present invention to automatically analyze procedures for digital signature and encryption to XML required by plural web services as described above, and automatically generate a program for performing digital signature and encryption to XML in accordance with a procedure that meets all the requirements, thereby reducing the burden on web service developers.

In the present invention, in order to solve the above-described problem, digital signature and encryption to XML are performed using the following steps:

(1) acquiring a protocol describing procedures for digital signature and encryption to XML from each of web services to be used, and acquiring a schema of an element to be a target of digital signature and encryption to XML;

(2) analyzing the protocol and the schema acquired at the above-described step, and outputting a proper procedure for digital signature and encryption to XML that meets all requirements;

(3) automatically generating a program for performing digital signature and encryption to XML in accordance with the procedure outputted at the above-described step; and

(4) when sending a message in a web service, executing the program for digital signature and encryption to XML generated at the above-described step in response to the message, and sending the result of the execution.

Instead of generating a program for digital signature and encryption to XML in advance as described above, analysis of the procedure for digital signature and encryption to XML and generation of a program for digital signature and encryption to XML may be carried out at the time of execution. In this case, digital signature and encryption to XML are performed using the following steps:

(1) when sending a message in a web service, specifying URI of a protocol for digital signature and encryption to XML and URI of a schema of an element to be a target of digital signature and encryption to XML from the description of the message, and acquiring the protocol and the schema;

(2) analyzing the protocol and the schema acquired at the above-described step, and outputting a proper procedure for digital signature and encryption to XML that meets all requirements;

(3) automatically generating a program for performing digital signature and encryption to XML in accordance with the procedure outputted at the above-described step; and

(4) executing the program for digital signature and encryption to XML generated at the above-described step in response to the message, and sending the result of the execution.

### BRIEF DESCRIPTION OF THE DRAWINGS

FIG. 1 shows a schematic system structure according to an embodiment of the present invention.

FIG. 2 is a structural view of hardware of the system structure.

FIG. 3 shows an example of a web service calling order defining screen 102.

FIG. 4 shows an example of a web service calling order 103.

FIG. 5 shows examples of an XML signature and encryption protocol 104.

FIG. 6 is a flowchart of an XML signature and encryption protocol acquiring section 105.

FIG. 7 shows an example of an XML signature and encryption protocol list 106.

FIG. 8 shows an example of an XML schema 108 of a target element.

FIG. 9 is a flowchart of an XML signature and encryption procedure analyzing section 107.

FIG. 10 shows an example of an XML signature and encryption procedure 109.

FIG. 11 is a flowchart of an XML signature and encryption module output section 110.

FIG. 12 is a flowchart of an XML signature and encryption module 111.

FIG. 13 is a flowchart of an XML signature and encryption module registering section 112.

FIG. 14 shows an example of an XML signature and encryption module correspondence table 113.

FIG. 15 is a flowchart of an XML signature and encryption executing section 114.

FIG. 16 shows an example of an XML document 115.

FIG. 17 shows an example of a web service transmission document 116.

FIG. 18 is a block diagram showing a system structure according to a second embodiment of the present invention.

### DETAILED DESCRIPTION OF THE PREFERRED EMBODIMENTS

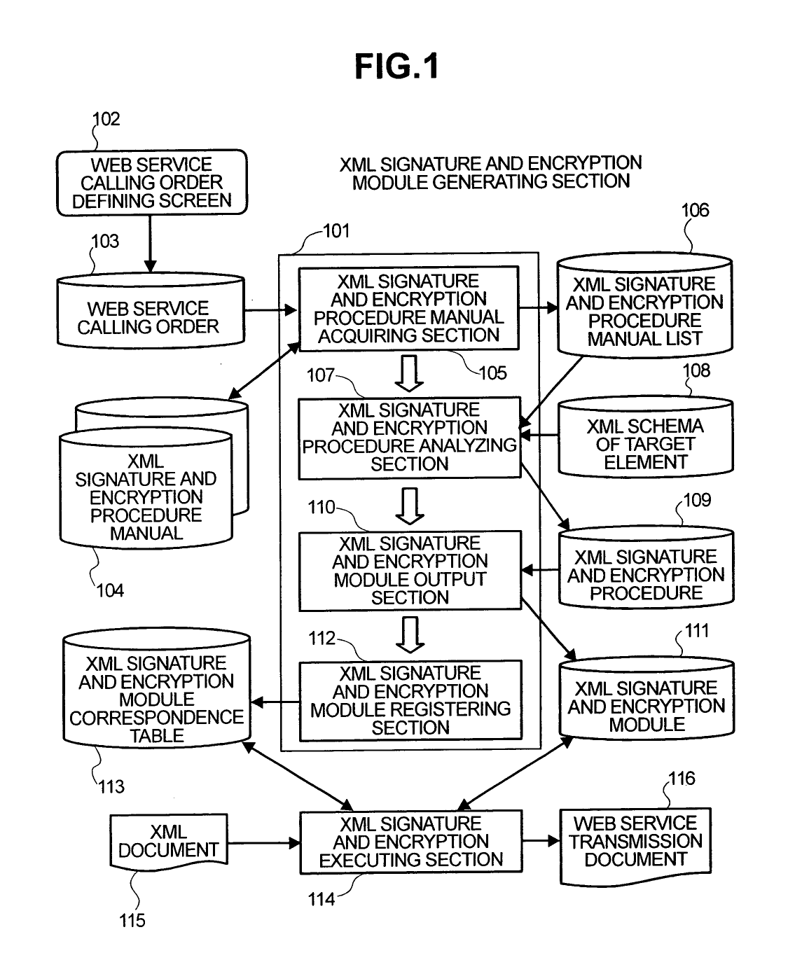

Hereinafter, a method for digital signature and encryption to XML according to an embodiment of the present invention will be described with reference to FIGS. 1 to 17.

First, the overview of the method for digital signature and encryption to XML according to this embodiment will be described with reference to FIG. 1. Each constituent part will be later described in detail. In the following case, it is assumed that a user newly develops a web service utilizing existing web services. First, the user uses a web service calling order defining screen 102 to define web services to be used in a newly developed web service and the calling order of these web services. The web service calling order defining screen 102 generates data 103 that describes the calling order of web services and URI of an XML signature and encryption protocol required by the respective web services.

An XML signature and encryption module generating section 101 is a processing section that generates a module for performing digital signature and encryption to XML. The XML signature and encryption module generating section 101 includes an XML signature and encryption protocol acquiring section 105, an XML signature and encryption procedure analyzing section 107, an XML signature and encryption module output section 110, and an XML signature and encryption module registering section 112.

When the data 103 is inputted, the XML signature and encryption module generating section 101 is called and the XML signature and encryption protocol acquiring section 105 is first executed. The XML signature and encryption protocol acquiring section 105 analyzes the data 103, then acquires XML signature and encryption protocols 104 from XML signature and encryption protocol URI of the respective web services described in the data 103, and outputs these XML signature and encryption protocols 104 as an XML signature and encryption protocol list 106.

Next, the XML signature and encryption procedure analyzing section 107 is executed. The XML signature and encryption procedure analyzing section 107 reads the XML signature and encryption protocol list 106 and an XML schema 108 of an element to be a target of digital signature and encryption to XML, then analyzes a procedure for digital signature and encryption to XML that meets all the required procedures in the list 106, and outputs the procedure decided as a result of the analysis, as an XML signature and encryption procedure 109.

Next, the XML signature and encryption module output section 110 is executed. The XML signature and encryption module output section 110 analyzes the XML signature and encryption procedure 109 and generates an XML signature and encryption module 111 for performing digital signature and encryption to XML in accordance with the procedure described in the XML signature and encryption procedure 109 with respect to an XML document conformable to the schema 108.

Next, the XML signature and encryption module registering section 112 is executed. The XML signature and encryption module registering section 112 registers the correspondence between the XML schema 108, the web service calling order of the data 103 and the XML signature and encryption module 111 to an XML signature and encryption module correspondence table 113.

When executing the XML signature and encryption module, the following operation is carried out. An XML signature and encryption executing section 114 receives an XML document 115 conformable to the schema 108, then decides a corresponding XML signature and encryption module from information of XML schema and web service calling order described in the XML document 115 and the XML signature and encryption module correspondence table 113, and executes the module with respect to the XML document 115. An XML document 116 obtained as a result of the execution is sent as a web service transmission document.

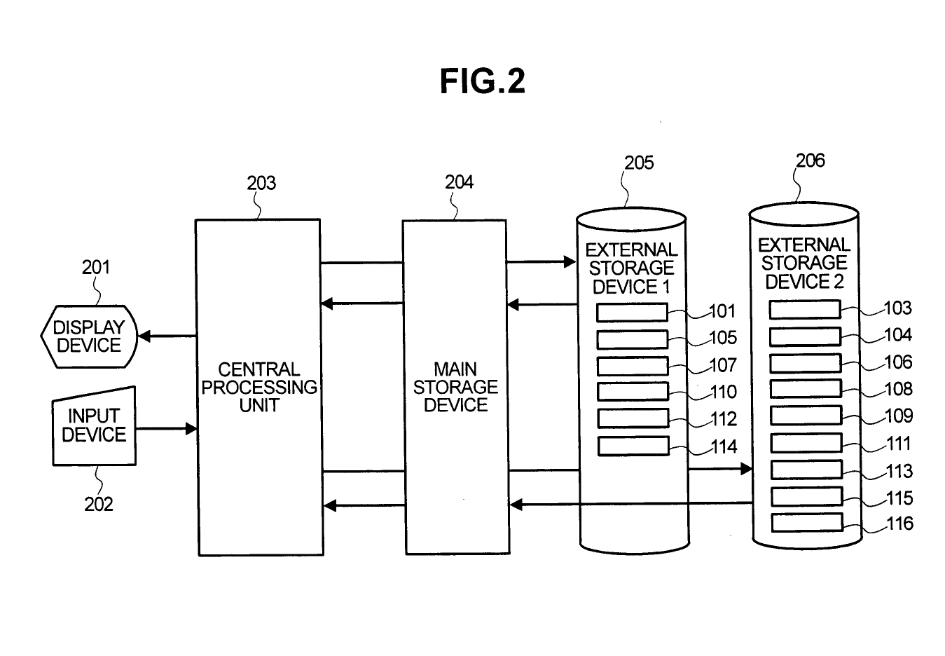

The hardware structure of the whole system will now be described with reference to FIG. 2. An external storage device (1) 205, is an external storage device in which programs are stored. In the external storage device (1) 205, the programs 101, 105, 107, 110, 112 and 114 are stored. An external storage device (2) 206, is an external storage device in which data are stored. In the external storage device (2) 206, the data 103, 104, 106, 108, 109, 111, 113, 115 and 116 are stored. 203 represents a central processing unit. 204 represents a main storage device. When a program stored in the external storage device 205 is called, the content of the program is read to the main storage device 204 and processed by the central processing unit 203. When the program needs data stored in the external storage device 206, the content of the data is read to the main storage device 204 and processed by the program. When the program outputs data in the main storage device 204 to the external storage device, the content of the data is written to the external storage device 206. 201 represents a display device such as a CRT display. 202 represents an input device such as a keyboard and a mouse.

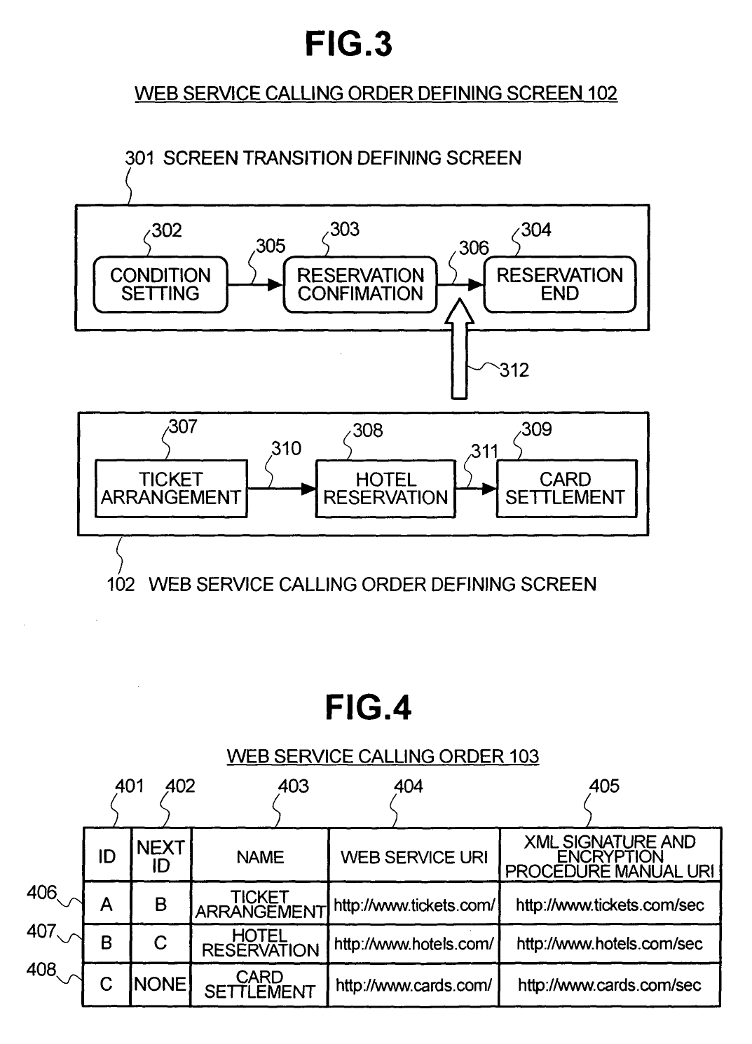

FIG. 3 shows an example of the web service calling order defining screen 102. 301 represents an exemplary screen transition defining screen for defining screens of a system to be developed and transition among these screens. 302 to 304 represent screens. 305 and 306 represent screen transitions. The web service calling order defining screen 102 is a screen for defining the names of web services to be called and a calling order of these web services. 307 to 309 represent web services. 310 and 311 represent a calling order of these web services. 312 indicates that the ticket arrangement service 307, the hotel reservation service 308 and the card settlement service 309 are called in this order, as web services to be called during the screen transition 306.

FIG. 4 shows an example of the web service calling order 103 defined on the web service calling order defining screen 102. Rows 406 to 408 correspond to information defined for the web services 307 to 309, respectively. ID 401 is an identifier for univocally specifying each web service within a tool. Next ID 402 is an identifier of the next web service to be called and refers to one of the values of ID 401. For example, if the next ID in the row 406 is B, which is ID of the hotel reservation service, it represents the web service calling order indicated by 310. Name 403 is a name of a web service, and web service URI 404 is an identifier for univocally specifying the web service on the Internet. XML signature and encryption protocol URI 405 is an identifier for univocally specifying an XML signature and encryption protocol describing an XML signature and encryption procedure required by the web service, on the Internet.

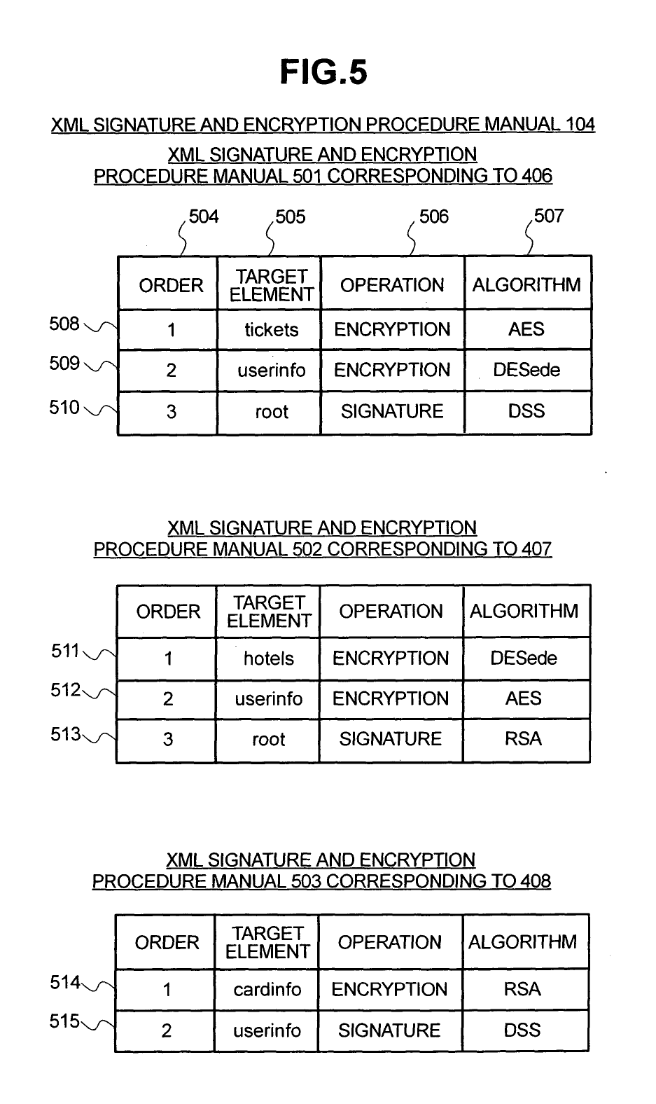

FIG. 5 shows example of the XML signature and encryption protocol 104. It is assumed that XML signature and encryption protocols 501 to 503 are described in the XML signature and encryption protocol URI 405 corresponding to the rows 406 to 408. The XML signature and encryption protocol 501 has the following contents. First, a “tickets” element, for which the value of order 504 is 1, is encrypted by an AES algorithm (508). Next, a “userinfo” element, for which the value of order is 2, is encrypted by a DESede algorithm (509). Finally, digital signature to a “root” element, for which the value of order is 3, is performed by a DSS algorithm (510). That is, in the web service using the ticket arrangement service, an XML document on which digital signature and encryption to XML have been performed in accordance with this procedure must be sent. Similar explanations apply to the XML signature and encryption protocols 502 and 503.

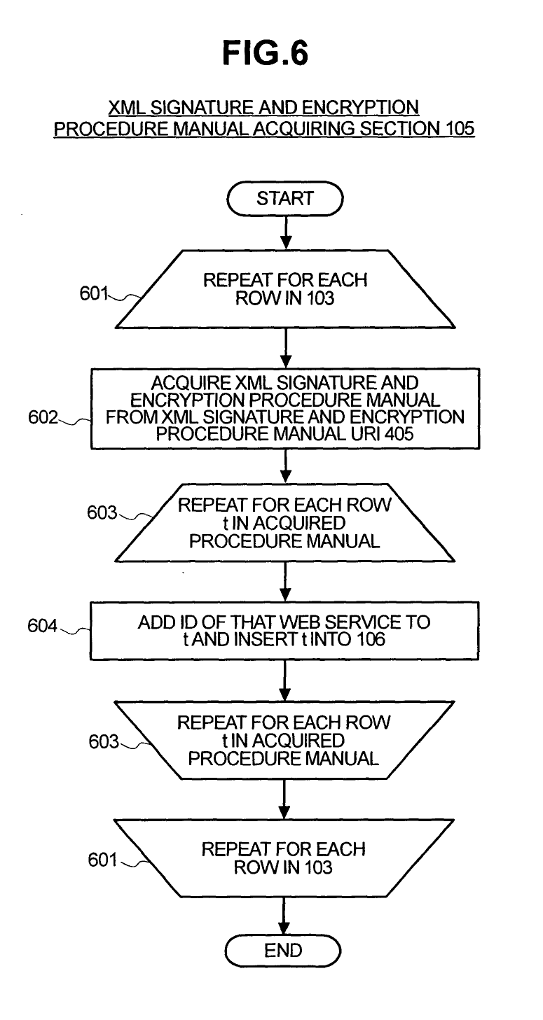

FIG. 6 is an exemplary flowchart of the XML signature and encryption protocol acquiring section 105. Hereinafter, operations in acquiring an XML signature and encryption protocol will be described with reference to this flowchart. With respect to each row in the web service calling order 103 shown in FIG. 4, the following steps 602 to 604 are carried out (601). First, an XML signature and encryption protocol is acquired from URI expressed by the XML signature and encryption protocol URI 405 in the web service calling order 103 (602). Next, for each row t in the protocol acquired at step 602, the following step 604 is carried out (603). At step 604, ID of the web service is added to t and t is inserted into the XML signature and encryption protocol list 106.

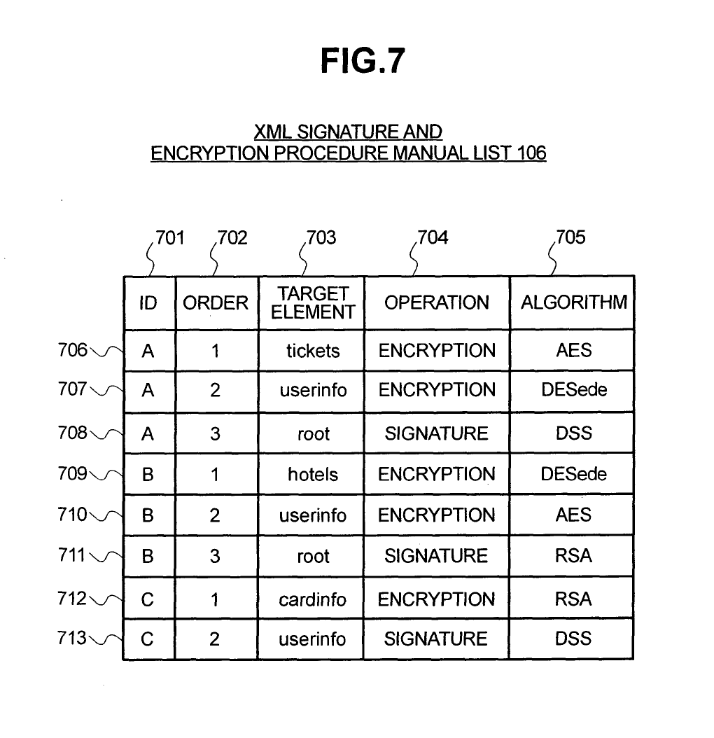

FIG. 7 is an example of the XML signature and encryption protocol list 106 obtained as a result of executing the flowchart of the XML signature and encryption protocol acquiring section 105 shown in FIG. 6 with respect to the web service calling order 103 shown in FIG. 4. In this example, 706 to 713 represent rows obtained by adding ID of corresponding web services to the rows 508 to 515.

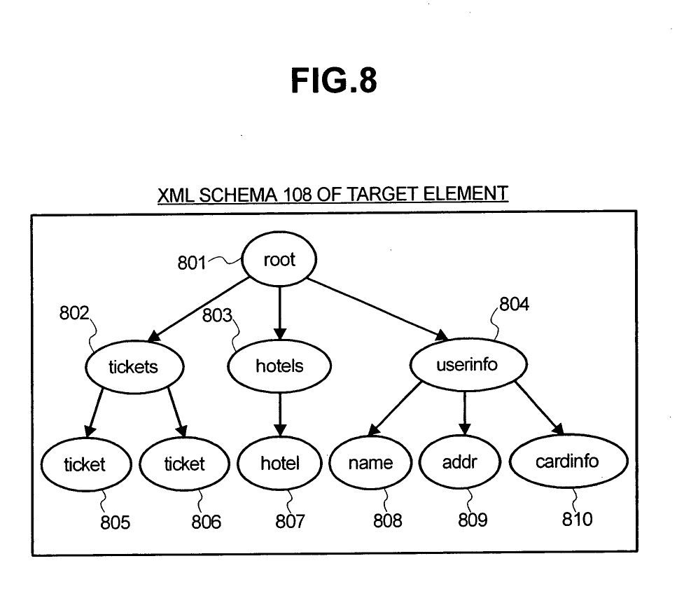

FIG. 8 shows an example of the schema 108 of an XML element to be a target of digital signature and encryption to XML, in a tree structure. In this example, a “root” element 801 is a document type. The “root” element 801 has a “tickets” element 802, a “hotels” element 803 and a “userinfo” element 804, as its child elements. Similar explanations apply to the other elements.

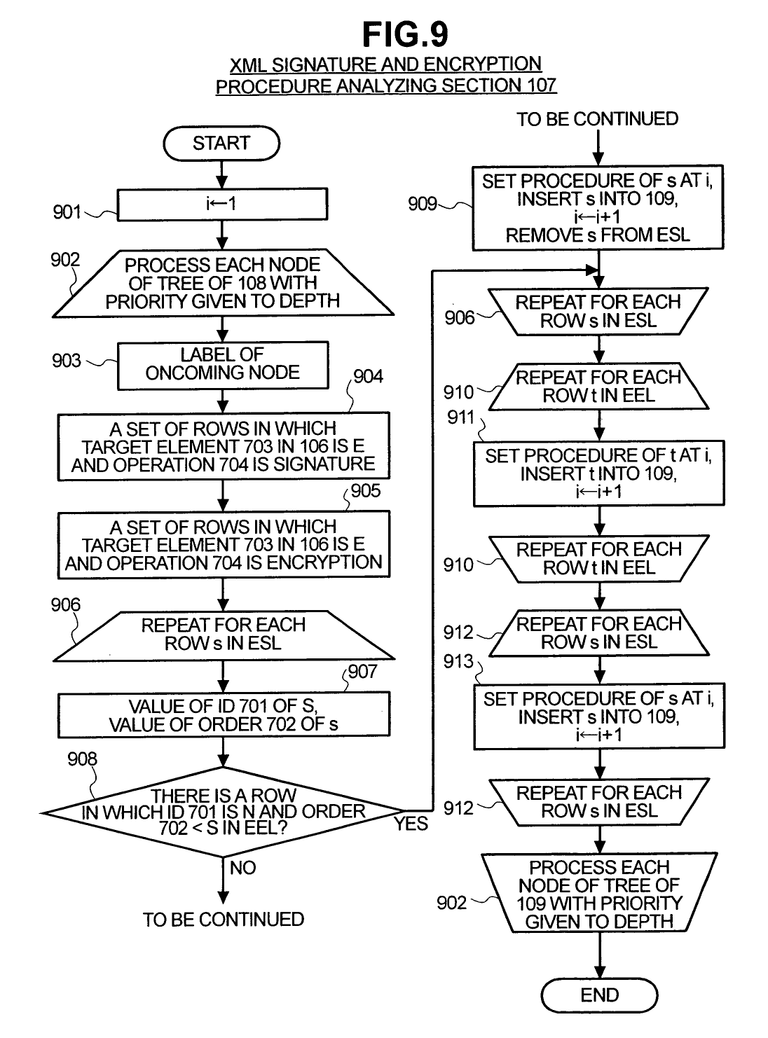

FIG. 9 is an exemplary flowchart of the XML signature and encryption procedure analyzing section 107. Hereinafter, operations in analyzing an XML signature and encryption procedure will be described with reference to this flowchart. First, the value of a variable i is initialized to 1 (901). Next, as the XML schema 108 is expressed in the form of tree structure as shown in FIG. 8, the tree is searched with priority given to its depth, and the following steps 903 to 913 are carried out for each oncoming node (902). First, the label (expressing the element name) of an oncoming node is substituted in a variable E (903). Next, a set of rows is found in which the value of target element 703 in the XML signature and encryption protocol list 106 shown in FIG. 7 is E and the value of operation 704 is “signature”, and the set is referred to as ESL (904). Similarly, a set of rows is found in which the value of target element in the XML signature and encryption protocol list 106 is E and the value of operation is “encryption”, and the set is referred to as EEL (905).

Next, the following steps 907 to 909 are carried out for each row s in the set ESL (906). First, the value of ID 701 of the row s is set at N, and the value of order 702 of the row s is set at S (907). Next, it is judged whether there is a row having an ID value equal to N and an order value smaller than S in the set EEL (908). If there is no such row, the value of procedure of the row s is set at i, and the row s is inserted into the XML signature and encryption procedure 109. After that, the value of i is increased by 1 and the row s is removed from ESL (909).

Next, the following step 911 is carried out for each row t in the set EEL (910). At step 911, the procedure value of t is set at i, and t is inserted into the XML signature and encryption procedure 109. After that, the value of i is increased by 1.

Finally, the following step 913 is carried out for each row s in the set ESL (912). At step 913, the procedure value of the row s is set at i, and the row s is inserted into the XML signature and encryption procedure 109. After that, the value of i is increased by 1.

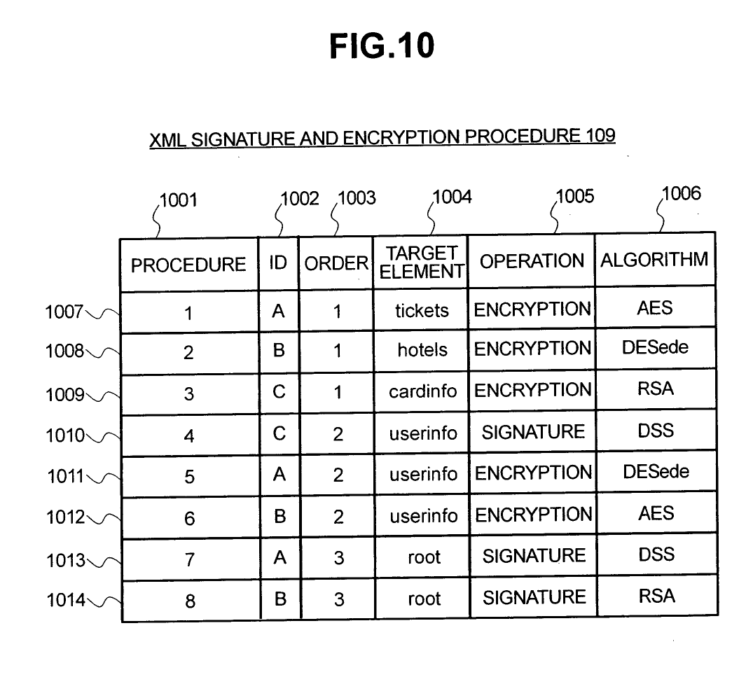

FIG. 10 is an example of the XML signature and encryption procedure 109 obtained as a result of executing the flowchart of the XML signature and encryption procedure analyzing section 107 shown in FIG. 9 with respect to the XML signature and encryption protocol list 106 shown in FIG. 7 and the XML schema 108 of the target element shown in FIG. 8. Hereinafter, operations of the XML signature and encryption procedure analyzing section 107 will be described. When the tree of the XML schema 108 is searched with priority given to its depth, oncoming nodes are in the order of 805, 806, 802, 807, 803, 808, 809, 810, 804, and 801. In repeated execution with respect to the nodes 805 and 806, the value of E is “tickets” at step 903, but there is no such row that the value of target element 703 is “tickets” in the XML signature and encryption protocol list 106. Therefore, the processing of steps 906 to 913 is not executed. In repeated execution with respect to the node 802, the value of E is “tickets” and ESL is an empty set. However, EEL includes the row 706 in which the value of target element is “tickets” and the value of operation 704 is “encryption”. Therefore, at step 911, the procedure value of the row 706 is 1 and the row 706 is inserted in the XML signature and encryption procedure 109. Similar operations apply to repeated execution with respect to the nodes 807, 803, 808, 809, and 810.

Repeated execution with respect to the node 804 will now be described. In this case, the value of E is “userinfo”, and ESL includes the row 713 in which the value of target element is “userinfo” and the value of operation 704 is “signature”. EEL includes the rows 707 and 710 in which the value of signature target is “userinfo” and the value of operation is “encryption”. At step 907, C, which is the ID value of the row 713, is substituted into the variable N, and 2, which is the order value of the row 713 is substituted into the variable S. Next, at step 908, it is judged whether there is a row having an ID value equal to C and an order value smaller than 2 in EEL. In this example, since there is no such row, step 909 is executed. The procedure value of the row 713 is set to be 4, and the row 713 is inserted into the XML signature and encryption procedure 109. After that, the row 713 is removed from ESL.

Next, step 911 is executed with respect to the rows 707 and 710. The procedure values of these rows are set to be 5 and 6, respectively, and these rows are inserted into the XML signature and encryption procedure 109. Since ESL is an empty set in execution of step 912, the processing of step 913 is not executed. The operations in repeated execution with respect to the “root” element 801 are similar to the above-described operations and therefore will not be described further in detail. The XML signature and encryption procedure 109 is thus obtained.

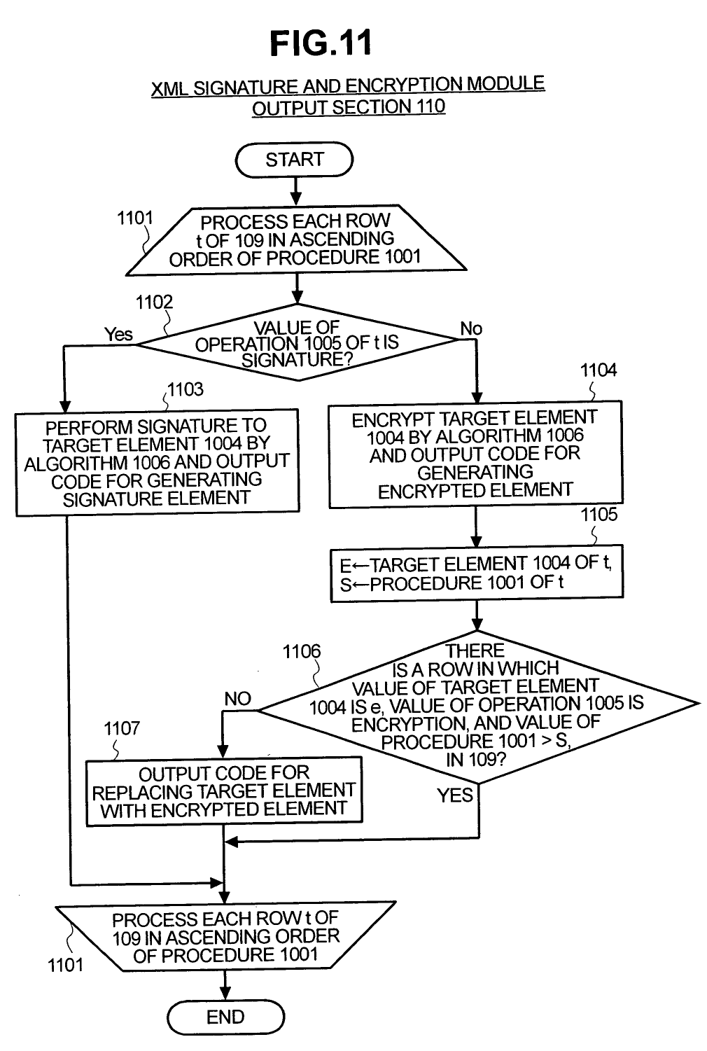

FIG. 11 is an exemplary flowchart of the XML signature and encryption module output section 110. Hereinafter, operations in outputting an XML signature and encryption module will be described with reference to this flowchart. The values of procedure 1001 of respective rows t in the XML signature and encryption procedure 109 are acquired in ascending order, and the following steps 1102 to 1107 are carried out (1101). First, whether or not the value of operation 1005 of the row t is “signature” is judged (1102). If so, signature to target element 1004 of the row t is performed by algorithm 1006, and a program code for generating a signature element is outputted (1103). If not, the following steps 1104 to 1107 are carried out. First, the target element 1004 of the row t is encrypted by the algorithm 1006, and a program code for generating an encrypted element is outputted (1104). Next, the value of the variable E is set at the value of target element 1004 of the row t, and the value of the variable S is set at the value of procedure 1001 of the row t (1105). Next, it is judged whether there is a row in which the value of target element is E, the value of operation is “encryption”, and the value of procedure is larger than S, in the XML signature and encryption procedure 109 (1106). If there is no such row, a program code for replacing the target element with the encrypted element generated at step 1104 is outputted (1107).

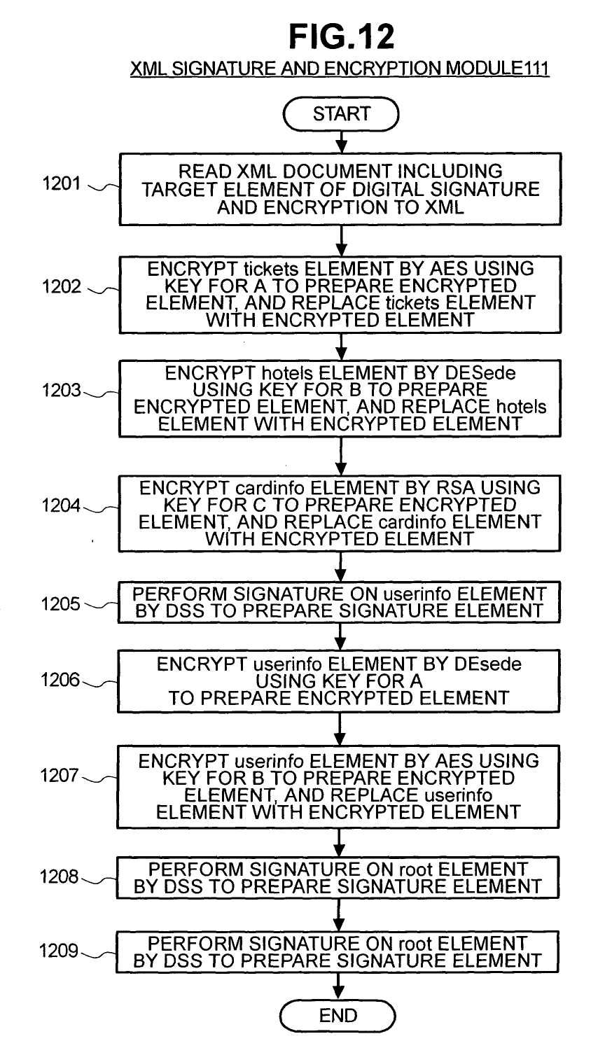

FIG. 12 is an exemplary flowchart of the XML signature and encryption module 111 obtained as a result of executing the flowchart of the XML signature and encryption module output section 110 shown in FIG. 11 with respect to the XML signature and encryption procedure 109 shown in FIG. 10. Hereinafter, operations of the XML signature and encryption module will be described with reference to this flowchart. First, an XML document including a target element of digital signature and encryption to XML is read (1201). Next, the “tickets” element is encrypted by the AES algorithm using a key for A, thus preparing an encrypted element, and the “tickets” element is replaced with the prepared encrypted element (1202). Next, the “hotels” element is encrypted by the DESede algorithm using a key for B, thus preparing an encrypted element, and the “hotels” element is replaced with the prepared encrypted element (1203). Next, the “cardinfo” element is encrypted by the RSA algorithm using a key for C, thus preparing an encrypted element, and the “cardinfo” element is replaced with the prepared encrypted element (1204). Next, signature is performed on the “userinfo” element by the DSS algorithm, thus preparing a signature element (1205). Next, the “userinfo” element is encrypted by the DESede algorithm using the key for A, thus preparing an encrypted element (1206). Next, the “userinfo” element is encrypted by the AES algorithm using the key for B, thus preparing an encrypted element, and the “userinfo” element is replaced with the prepared encrypted element (1207). Then, signature is performed on the “root” element by the DSS algorithm, thus preparing a signature element (1208). Finally, signature is performed on the “root” element by the RSA algorithm, thus preparing a signature element (1209).

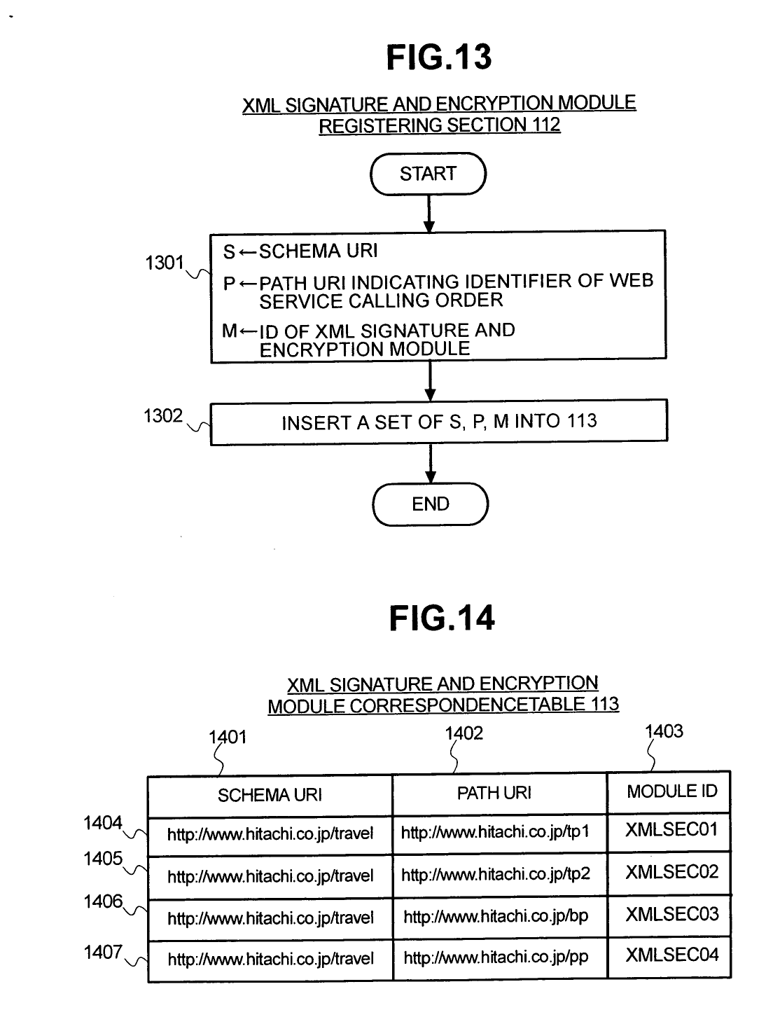

FIG. 13 is an exemplary flowchart of the XML signature and encryption module registering section 112. Hereinafter, operations in registering an XML signature and encryption module will be described with reference to this flowchart. First, the schema URI of the XML schema 108 is set to be S. Path URI, which is the identifier of the web service calling order 103, is set to be P. ID of the XML signature and encryption module prepared by the XML signature and encryption module output section 110 is set to be M (1301). Next, a set of S, P and M is inserted into the XML signature and encryption module correspondence table 113 (1302).

FIG. 14 shows an example of the XML signature and encryption module correspondence table 113. Every time a new XML signature and encryption module is generated by the XML signature and encryption module output section 110, a row corresponding to that module is inserted into the XML signature and encryption module correspondence table 113.

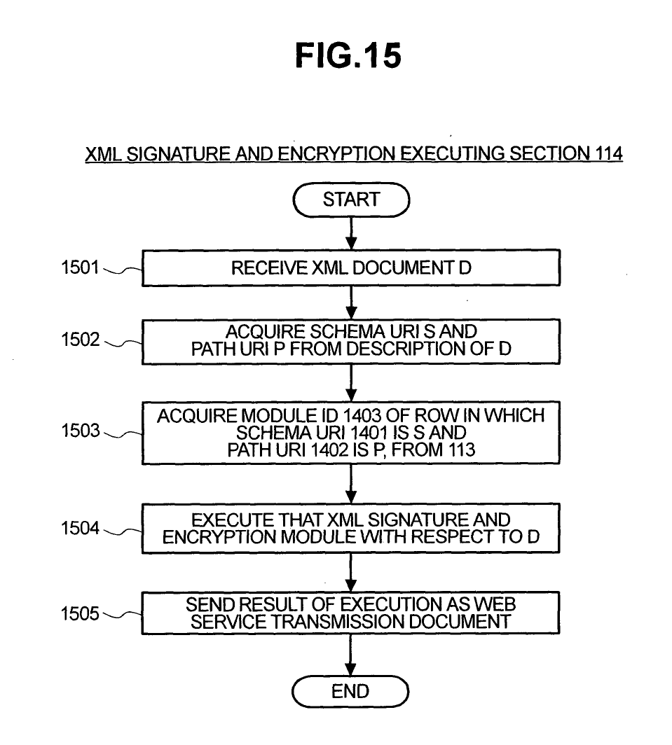

FIG. 15 is an exemplary flowchart of the XML signature and encryption executing section 114. Hereinafter, operations in executing XML signature and encryption will be described with reference to this flowchart. First, an XML document D including a target element of digital signature and encryption to XML is received (1501). Next, S representing schema URI and P representing path URI are acquired from the description of the XML document D (1502). Next, the XML signature and encryption module correspondence table 113 is searched for a row in which the value of schema URI 1401 is S and the value of path URI 1402 is P, and a corresponding XML signature and encryption module is decided from the value of module ID 1403 of that row (1503). Next, the XML signature and encryption module is executed with respect to the document D (1504). Finally, the result of the execution of the XML signature and encryption module is sent as a web service transmission document (1505).

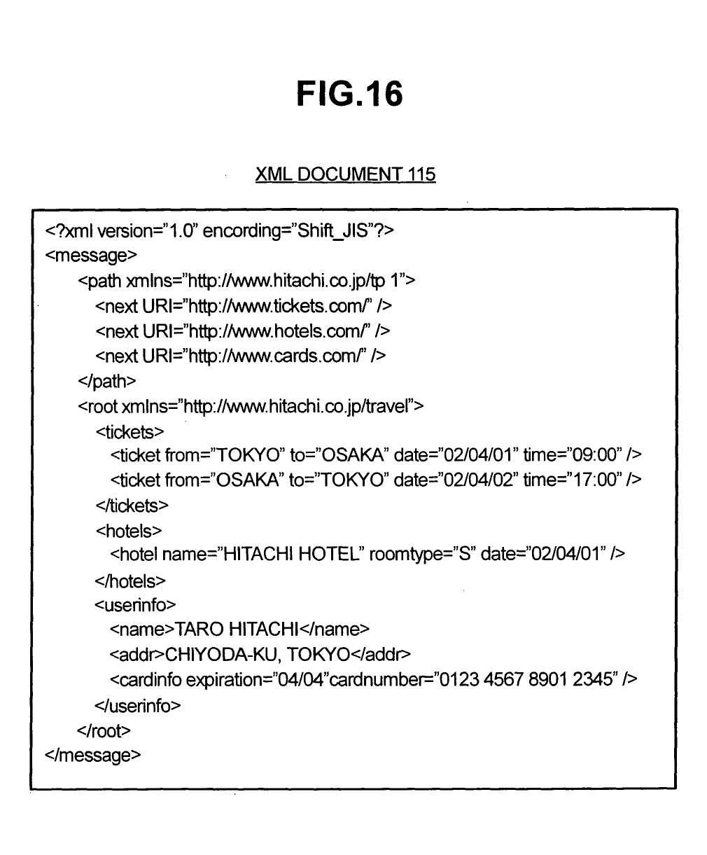

FIG. 16 shows an example of the XML document 115. In this example, a “path” element is an element indicating the web service calling order, and a “root” element is an element having a format conformable to the XML schema 108. The value of xmlns attribute of the “path” element represents path URI, and the value of xmlns attribute of the “root” element represents schema URI.

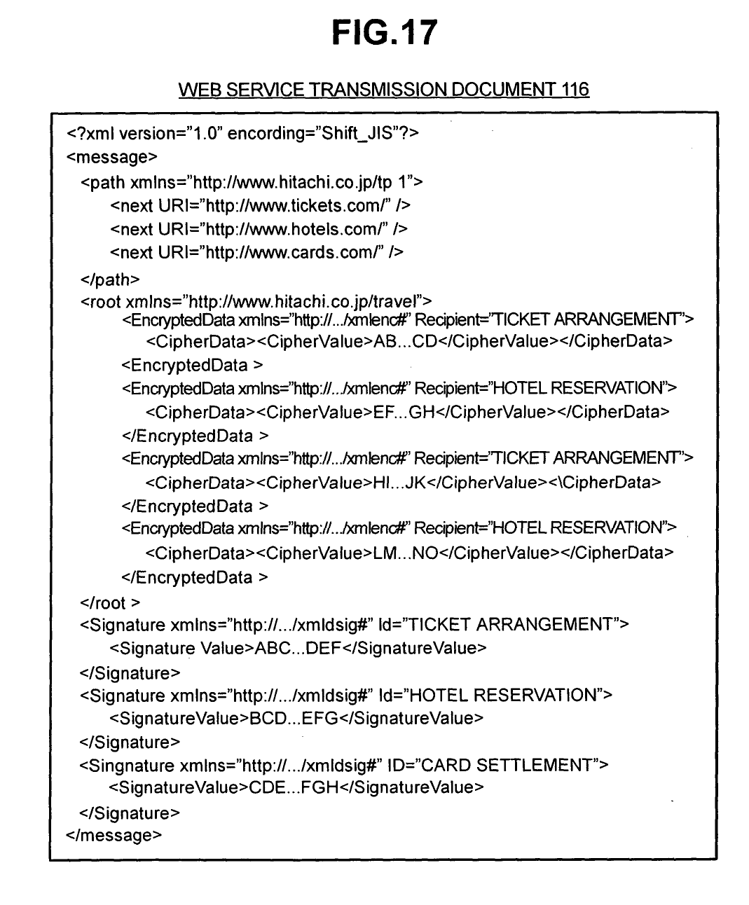

FIG. 17 shows an example of the web service transmission document obtained as a result of executing the flowchart of the XML signature and encryption executing section 114 shown in FIG. 15 with respect to the XML document 115 shown in FIG. 16. The description is partly omitted. In this example, “Signature” element and “EncryptedData” element are the signature element and encrypted element generated by the XML signature and encryption module 111. In this example, ID of the XML signature and encryption module to be executed by the XML signature and encryption executing section 114 is “XMLSEC01”, which the value of module ID 1403 of the row 1404 having the corresponding schema URI value and path URI value shown in the XML document 115.

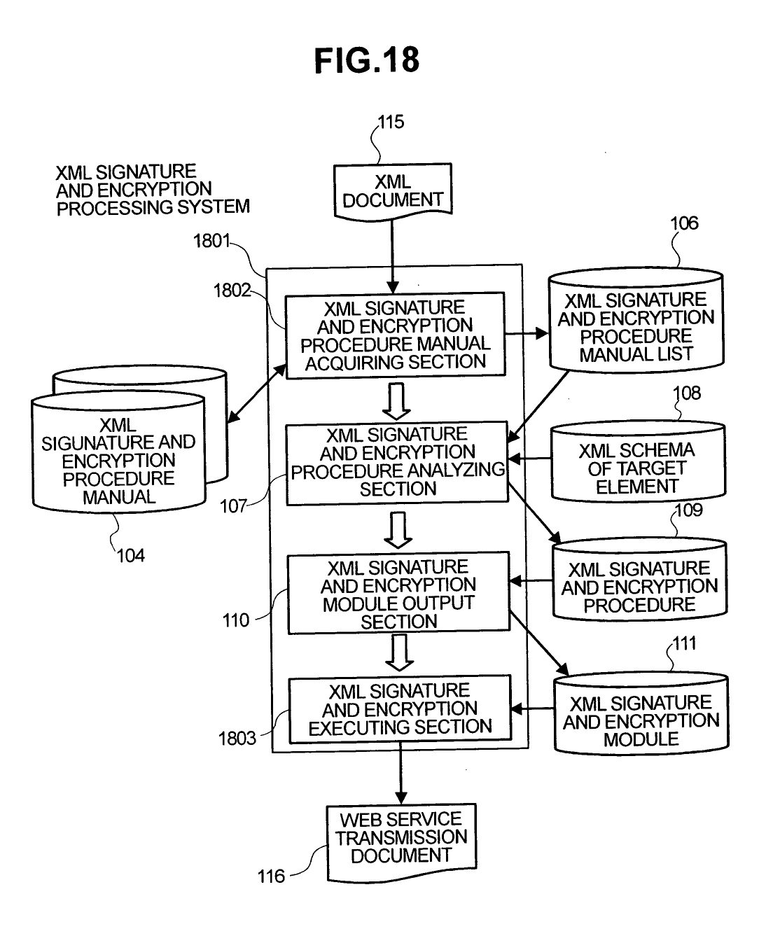

A method for digital signature and encryption to XML according to a second embodiment of the present invention will now be described with reference to FIG. 18. In the first embodiment, an XML signature and encryption module is prepared in advance at the time of development, and that module is called at the time of execution. In the second embodiment, however, analysis of an XML signature and encryption procedure and generation of an XML signature and encryption module are carried out at the time of execution.

FIG. 18 shows an overview of the method for digital signature and encryption to XML according to this embodiment. An XML signature and encryption processing system 1801 includes an XML signature and encryption protocol acquiring section 1802, the XML signature and encryption procedure analyzing section 107, the XML signature and encryption module output section 110, and an XML signature and encryption executing section 1803.

As the XML document 115 is inputted, the XML signature and encryption processing system 1801 is called and the XML signature and encryption protocol acquiring section 1802 is executed first. The XML signature and encryption protocol acquiring section 1802 acquires an XML signature and encryption protocol of each web service on the basis of web service URI described in the XML document. The method for preparing the XML signature and encryption protocol list 106 is similar to the method used in the XML signature and encryption protocol acquiring section 105. After that, the processing to the generation of the XML signature and encryption module 111 is similar to that of the first embodiment.

The XML signature and encryption executing section 1803 executes the XML signature and encryption module 111 generated by the XML signature and encryption module output section 110 with respect to the XML document 115, and sends the XML document 116 obtained as a result of the execution, as a web service transmission document.

According to the present invention, when newly developing a web service utilizing plural web services, a module for performing digital signature and encryption to XML in accordance with all the XML signature and encryption procedures required the web services to be used is automatically generated. Therefore, the burden on developers can be reduced.

What is claimed is:

1. A system of generating procedure for digital signature and encryption to an XML document, comprising:
a unit for acquiring a protocol describing procedures for digital signature and encryption to XML from each of web services to be used;
a unit for acquiring a schema of an element to be a target of digital signature and encryption to XML from the protocol; and
a unit for analyzing the acquired protocol and schema and outputting a proper procedure for digital signature and encryption to XML that meets requirements of the protocol and schema.

2. The system of generating procedure for digital signature and encryption as claimed in claim 1, wherein a program for performing digital signature and encryption to XML in accordance with the procedure for digital signature and encryption to XML is automatically generated.

3. The system of generating procedure for digital signature and encryption as claimed in claim 2, wherein when sending a message in a web service, the generated program for digital signature and encryption to XML is executed for the message and the result of the execution is sent.

4. The system of generating procedure for digital signature and encryption as claimed in claim 2, wherein when generating the program for digital signature and encryption to XML, a correspondence between an identifier of an XML schema for an XML element to which digital signature and encryption to XML are to be performed, an identifier of a list of the protocols for digital signature and encryption to XML, and the program for digital signature and encryption to XML is stored into a storage device.

5. The system of generating procedure for digital signature and encryption as claimed in claim 4, wherein when sending an XML document, an XML signature and an encryption module are decided from the identifier of the XML schema and the identifier of the list of the protocols for digital signature and encryption to XML with reference to the correspondence, then the program for digital signature and encryption to XML is executed with respect to the XML document, and the result of the execution is sent.

6. The system of generating procedure for digital signature and encryption as claimed in claim 2, wherein when sending an XML document, a protocol for digital signature and encryption to XML is acquired according to an identifier of a web service described in the XML document, then a program for digital signature and encryption to XML is generated from the protocol for digital signature and encryption to XML, the program for digital signature and encryption to XML is executed with respect to the XML document, and the result of the execution is sent.
